(19) United States
(12) Patent Application Publication
(10) Pub. No.: US 2025/0360483 A1
(43) Pub. Date: Nov. 27, 2025

(54) Transition metal sulfide adsorbent and its preparation method and application

(71) Applicant: Jinggangshan University, Ji'an City (CN)

(72) Inventors: Kai Zhang, Ji'an City (CN); Xubiao Luo, Ji'an City (CN); Haichen Liu, Ji'an City (CN); Zhengwei Guo, Ji'an City (CN); Tianpeng Wu, Ji'an City (CN); Shengxuan Xie, Ji'an City (CN)

(73) Assignee: Jinggangshan University, Ji'an City (CN)

(21) Appl. No.: 19/295,533

(22) Filed: Aug. 8, 2025

(30) Foreign Application Priority Data
Dec. 6, 2024 (CN) 202411787870.8

(51) Int. Cl. B01J 20/02; C02F 1/28; C02F 1/62; C02F 101/20; C07F 11/00

(52) U.S. Cl. CPC B01J 20/0285; C02F 1/281; C02F 1/62; C07F 11/00; C02F 2101/20

(57) ABSTRACT

The present invention relates to the technical field of adsorbent materials, and specifically to a transition metal sulfide adsorbent, and methods of making and using. The transition metal sulfide adsorbent uses Mo-MOF as a template, calcines thiourea and Mo-MOF at a mass ratio of 3 to 4:1, and uses a high-temperature template pyrolysis method to prepare the transition metal sulfide adsorbent. The invention uses MOF template high-temperature pyrolysis to create an active center with both adsorption and reduction capabilities at the adsorption material reaction interface. The prepared MOF template-derived transition metal sulfide adsorbent material can achieve efficient selective removal and resource recovery of Ag⁺ in water bodies, which is of great significance for ensuring water environmental safety and maintaining the development of a green, low-carbon circular economy of silver resources. This new technology integrates selective adsorption and heavy metal elementalization for wastewater heavy metal low-carbonization treatment.

### TECHNICAL FIELD

The invention relates to the technical field of adsorbent materials, and in particular to a transition metal sulfide adsorbent and a preparation method and application thereof.

### BACKGROUND

As an important precious metal, silver has a wide range of applications in the fields of medicine, electronics, and chemicals. The latest data from the World Silver Association shows that global silver demand has increased by 16% year-on-year, and the silver gap is as high as 194 million ounces. However, mining limitations have led to a shortage of silver resources, and silver-containing wastewater, which accounts for about 10% of the raw materials each year, inevitably enters the hydrological environment. If these silver-containing wastewaters are not treated, they not only cause environmental pollution, they also lead to a huge waste of silver resources. Therefore, the recovery of silver wastewater resources is crucial to maintaining the integrity of the future supply chain and reducing environmental pollution.

Methods for removing and recovering silver from water bodies include cyanide solution or nitric acid extraction, ion exchange, reverse osmosis, and adsorption. However, these methods can cause further environmental problems, owing to the use of large amounts of chemical reagents, the generation of waste acid solutions and toxic fumes. Some studies have considered the conversion of Ag⁺ into insoluble precipitates, such as AgCl or Ag₂SO₄, but the process of reducing AgCl or Ag₂SO₄ to silver metal is complicated, involving high carbon emissions and high energy consumption. In comparison, adsorption is considered to be a competitive technical means for Ag⁺ removal due to its advantages such as low cost, simple operation, high efficiency and green environmental protection.

Currently-known adsorbents such as activated carbon, fly ash, expanded perlite, biosorbents, and electrospinning have been used to remove Ag⁺ from water bodies. However, these traditional adsorbents often have the disadvantages of low adsorption capacity, poor reusability and instability. In addition, the adsorbent materials prepared by existing methods usually need to be eluted and regenerated before reduction after the adsorption of Ag⁺ is completed. The whole process is cumbersome and complicated and produces a large amount of toxic acid and alkali waste liquid.

### SUMMARY

In view of the deficiencies of the above-mentioned prior art, the purpose of the present invention is to provide a transition metal sulfide adsorbent and a preparation method and application thereof. The transition metal sulfide adsorbent of the present invention uses Molybdenum-based metal-organic frameworks (Mo-MOF) as templates, mixes thiourea and Mo-MOF, and uses a high-temperature template pyrolysis method to prepare the transition metal sulfide adsorbent.

To solve the above-mentioned technical problems, the present invention adopts the following technical scheme:

A method for preparing a transition metal sulfide adsorbent, comprising the following steps:

Synthesizing the Mo-MOF template by a hydrothermal method.

Under a protective atmosphere, thiourea and the Mo-MOF template are placed on one side of a tube furnace and at the center of a heat source in a mass ratio of 3 to 4:1, respectively, and heated, and a transition metal sulfide adsorbent is obtained by a high-temperature template pyrolysis method.

The present invention uses a molybdenum-based metal organic framework as a template, calcines it with thiourea, and uses a high-temperature pyrolysis method to create an active center with both adsorption and reduction at the reaction interface of the adsorbent material. The prepared transition metal sulfide adsorbent derived from the molybdenum-based metal organic framework template can achieve efficient and selective removal of Ag⁺ in water. The present invention can inherit the large specific area and abundant pores of the original molybdenum-based metal organic framework through the template method, which is conducive to providing sufficient sites and transmission channels; the unstable coordination structure can be calcined by high-temperature calcination to form a stable framework, and the H₂S decomposed by thiourea at high temperature can form molybdenum sulfide with Mo⁴⁺ on the molybdenum-based metal organic framework, and the S atom can form Ag₂S with Ag⁺, and S can reduce Ag⁺. At the same time, the potential of Ag⁺ is higher than that of Mo⁴⁺. Ag⁺, as a weak oxidant, can oxidize Mo⁴⁺ and reduce Ag⁺ to elemental Ag⁰. Therefore, the transition metal sulfide adsorbent of the present invention has excellent adsorption selectivity for Ag⁺.

In a preferred embodiment of the present invention, the heating temperature is 1000° C.˜1200° C., and the calcination time is 1 hour-1.2 hours.

In a preferred embodiment of the present invention, the preparation method of the Mo-MOF template includes the following steps:

Dissolve the molybdenum source in water to form a uniformly dispersed solution.

Add imidazole to the uniformly dispersed solution, heat the reaction, and obtain the Mo-MOF template after post-treatment.

In a preferred embodiment of the present invention, the volume ratio of the molybdenum source mass to water is 4 g: 0.1 L˜0.3 L.

In a preferred embodiment of the present invention, the mass ratio of imidazole to molybdenum source is 4: 1-2.

In a preferred embodiment of the present invention, the heating reaction temperature is 100° C.˜200° C., and the heating reaction time is 12 h˜72 h.

The second object of the present invention is to provide a transition metal sulfide adsorbent obtained by any of the preparation methods described above.

In a preferred embodiment of the present invention, the transition metal sulfide adsorbent is a nanorod structure with a length of 10 μm˜20 μm and a diameter of 1 μm˜2 μm.

The third object of the present invention is to provide an application of the above-mentioned transition metal sulfide adsorbent in targeted adsorption of silver in silver-containing wastewater.

In a preferred embodiment of the present invention, the concentration of silver in the silver-containing wastewater is 50 mg/L˜2000 mg/L, and the dosage ratio of the transition metal sulfide molybdenum adsorbent to the silver-containing wastewater is 1 mg: 2 mL˜4 mL.

Compared with the prior art, the present invention has the following beneficial effects:

1. The present invention uses a molybdenum-based metal organic framework as a template, calcines it with thiourea, and uses a high-temperature pyrolysis method to create an active center with both adsorption and reduction at the reaction interface of the adsorbent material. The prepared transition metal sulfide adsorbent material derived from the molybdenum-based metal organic framework template can achieve efficient and selective removal of Ag⁺ in water. The present invention can inherit the large specific area and abundant pores of the original molybdenum-based metal organic framework through the template method, which is conducive to providing sufficient sites and transmission channels; the unstable coordination structure can be calcined by high-temperature calcination to form a stable framework, and the H₂S decomposed by thiourea at high temperature can form molybdenum sulfide with Mo⁴⁺ on the molybdenum-based metal organic framework, and the S atom can form Ag₂S with Ag⁺, and S can reduce Ag⁺. At the same time, the potential of Ag⁺ is higher than that of Mo⁴⁺. Ag⁺, as a weak oxidant, can oxidize Mo⁴⁺ and reduce Ag⁺ to elemental Ag⁰. Therefore, the transition metal sulfide adsorbent of the present invention has excellent adsorption selectivity for Ag⁺.

2. The present invention utilizes Mo-MOF as a template to construct a derived transition metal sulfide adsorption material, thereby providing a porous adsorption material with both selective and reductive adsorption sites in one site for the resource utilization of Ag⁺, which is of great significance for ensuring water environmental safety and maintaining the development of a green, low-carbon circular economy of silver resources, and provides a prototype new technology that integrates selective adsorption and heavy metal elementalization for the low-carbonization technology of wastewater heavy metals.

### BRIEF DESCRIPTION OF THE DRAWINGS

FIG. 1 is a diagram of the preparation process of the present invention.

FIG. 2 is a morphology diagram of the transition metal sulfide adsorbent material prepared by Example 1-Example 2 and Comparative Example 1-Comparative Example 3 of the present invention.

FIG. 3 is a diagram of the adsorption capacity results of thiourea and Mo-MOF at different ratios of the transition metal sulfide adsorbent material prepared by Example 1 and Example 3 of the present invention and Comparative Example 4 and Comparative Example 5 of the present invention at different calcination temperatures.

FIG. 4 is a diagram of the adsorption capacity results of the transition metal sulfide adsorbent materials prepared in Examples 1 and 2 of the present invention and Comparative Examples 1 to 3 at different calcination temperatures.

FIG. 5 is a diagram of the affinity of the transition metal sulfide adsorbent prepared by Example 1 of the present invention for Ag⁺ in the presence of coexisting ions.

### DETAILED DESCRIPTION OF EMBODIMENTS

In combination with the embodiments of the present invention, the technical scheme in the embodiments of the present invention is clearly and completely described with preferred embodiments and drawings in conjunction with detailed descriptions. Obviously, the described embodiments are only part of the embodiments of the present invention, not all embodiments. Based on the embodiments of the present invention, all other embodiments obtained by ordinary technicians in the field without creative work are within the scope of protection of the present invention.

It should be noted that all professional terms used in the present invention are only for the purpose of describing specific embodiments, and are not intended to limit the scope of protection of the present invention. Unless otherwise specified, the various raw materials, reagents, instruments and equipment used in the following embodiments of the present invention can be purchased from the market or prepared by existing methods.

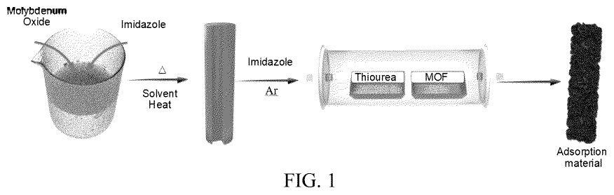

Metal organic frameworks and transition metal sulfides, as representatives of porous materials, show outstanding application prospects in the removal of Ag⁺ in water. Metal organic frameworks are an emerging class of porous crystalline solids in which metal ions or metal clusters are combined with organic ligands through organic linkers, with high porosity and open nodes. However, the coordination bonds between the metal active centers and organic ligands in metal organic framework adsorption materials are often fragile, making the metal organic framework unstable in water, resulting in structural collapse, thereby causing site failure and reducing its adsorption performance. Transition metal sulfides are endowed with high interfacial reactivity due to the size homogenization effect. However, transition metal sulfides are easy to agglomerate in water, resulting in limited exposed sites or insufficient site utilization. Therefore, the present invention provides a transition metal sulfide adsorbent, wherein the transition metal sulfide is templated with Mo-MOF, thiourea and Mo-MOF are calcined at a mass ratio of 3 to 4:1, and the transition metal sulfide adsorbent is prepared by a high-temperature template pyrolysis method. The preparation process is shown in FIG. 1.

Active centers with both adsorption and reduction are created at the reaction interface of the adsorbent material. The prepared MOF template-derived transition metal sulfide adsorbent can achieve efficient and selective removal of Ag⁺ in water. The present invention can inherit the large size of the original Mo-MOF through the template method. The specific area and abundant pores are conducive to providing sufficient sites and transmission channels; high-temperature calcination can burn off the unstable coordination structure to form a stable framework, and the H₂S decomposed by thiourea at high temperature can form molybdenum sulfide with Mo⁴⁺ on Mo-MOF, and the S atom can form Ag₂S with Ag⁺, and S can reduce Ag⁺; at the same time, the potential of Ag⁺ is higher than that of Mo⁴⁺, and Ag⁺ as a weak oxidant can oxidize Mo⁴⁺ and reduce Ag⁺ to elemental Ag⁰, so the transition metal sulfide adsorbent of the present invention has excellent adsorption selectivity for Ag⁺.

### Example 1

A method for preparing a transition metal sulfide adsorbent comprises the following steps:

(1) Weigh 0.8 g of molybdenum trioxide and dissolve it in a single-necked flask containing 60 mL of deionized water and 100 mL of solvent, and ultrasonically stir for 10 min to form a uniformly dispersed solution.

(2) Add 0.2 g of imidazole to the uniformly dispersed solution until it is fully mixed and then continuously ultrasonically stir for 10 min.

(3) Put a polytetrafluoroethylene magnetic stirring bar on the three-necked flask, transfer the single-necked flask containing the mixture to a constant temperature oil bath for heating reaction, the oil bath temperature is constant controlled at 120° C., and condensed water is introduced for condensation reflux. The reaction time is 24 h, and the mechanical stirring speed is controlled at 300 rmp/min.

(4) After the reaction, cool the single-necked flask at room temperature, filter the white precipitate in the single-necked flask, wash the precipitate with deionized water three times and ethanol three times, and finally dry the white solid in a vacuum drying oven at 80° C. for 24 h. The white powder obtained by grinding is Mo-MOF.

(5) Transfer thiourea to the porcelain boat marked No. 1 and weigh the Mo-MOF in the porcelain boats marked No. 1 and No. 2 at a mass ratio of 3:1. At the same time, the two raw materials need to be evenly spread in their respective magnetic boats.

(6) Place the porcelain boat marked as No. 1 on the upstream side of the tube furnace, that is, on the side of the argon inlet, and place the porcelain boat marked as No. 2 on the heat source center of the tube furnace. The two porcelain boats are adjacent to each other. Before heating the tube furnace, first introduce argon for 1 h to remove oxygen in the tube furnace. After removing the oxygen in the tube furnace, set the temperature of the tube furnace to 1000° C., and program the temperature at a rate of 5° C. min⁻¹. Heat the tube furnace under the protection of Ar gas, and continue calcining at high temperature for 1 h.

(7) Stop the reaction, wait for it to cool naturally to room temperature, grind and collect the black product after the reaction to obtain a transition metal sulfide adsorbent, named MS-1000.

### Example 2

A method for preparing a transition metal sulfide adsorbent comprises the following steps:

(1) Weigh 0.8 g of molybdenum trioxide and dissolve it in a single-necked flask containing 60 mL of deionized water and 100 mL of solvent, and perform ultrasonic stirring for 10 min to form a uniformly dispersed solution.

(2) Add 0.2 g of imidazole to the uniformly dispersed solution until fully mixed and then continuously ultrasonically stir for 10 min.

(3) Put a polytetrafluoroethylene magnetic stirring bar on the three-necked flask, transfer the single-necked flask containing the mixture to a constant temperature oil bath for heating reaction, the oil bath temperature is constant controlled at 120° C., and condensed water is introduced for condensation reflux. The reaction time is 24 h, and the mechanical stirring speed is controlled at 300 rmp/min.

(4) After the reaction, cool the single-necked flask at room temperature, filter the white precipitate in the single-necked flask, wash the precipitate three times with deionized water and three times with ethanol, and finally dry the white solid in a vacuum drying oven at 80° C. for 24 h. The white powder obtained by grinding is Mo-MOF.

(5) Transfer thiourea to the porcelain boat marked No. 1 and weigh the Mo-MOF in the porcelain boats marked No. 1 and No. 2 in a mass ratio of 3:1. At the same time, the two raw materials need to be evenly spread in their respective magnetic boats.

(6) Place the porcelain boat marked as No. 1 on the upstream side of the tube furnace, that is, on the side of the argon inlet, and place the porcelain boat marked as No. 2 on the heat source center of the tube furnace. The two porcelain boats are adjacent to each other. Before heating the tube furnace, first introduce argon gas for 1 h to remove oxygen in the tube furnace. After removing the oxygen in the tube furnace, set the temperature of the tube furnace to 1200° C., and program the temperature at a rate of 5° C. min⁻¹. Heat the tube furnace under the protection of Ar gas, and continue calcining at high temperature for 1 h.

(7) Stop the reaction, wait for it to cool naturally to room temperature, grind and collect the black product after the reaction to obtain a transition metal sulfide adsorbent, named MS-1200.

### Example 3

A method for preparing a transition metal sulfide adsorbent comprises the following steps:

(1) Weigh 0.89 g of molybdenum trioxide and dissolve it in a single-necked flask containing 60 mL of deionized water and 100 mL of solvent, and perform ultrasonic stirring for 10 min to form a uniformly dispersed solution.

(2) Add 0.2 g of imidazole to the uniformly dispersed solution and stir continuously with ultrasonic stirring for 10 min until fully mixed.

(3) Put a polytetrafluoroethylene magnetic stirring bar on the three-necked flask, transfer the single-necked flask containing the mixture to a constant temperature oil bath for heating reaction, the oil bath temperature is constant controlled at 120° C., condensed water is introduced for condensation reflux, the reaction time is 24 h, and the mechanical stirring speed is controlled at 300 rmp/min.

(4) After the reaction, cool the single-necked flask at room temperature, filter the white precipitate in the single-necked flask, wash the precipitate with deionized water three times and ethanol three times, and finally dry the white solid in a vacuum drying oven at 80° C. for 24 h. The white powder obtained by grinding is Mo-MOF.

(5) Transfer thiourea to the porcelain boat marked No. 1 and weigh the Mo-MOF in the porcelain boats marked No. 1 and No. 2 in a mass ratio of 4:1, and at the same time, the two raw materials need to be evenly spread in their respective magnetic boats.

(6) Place the porcelain boat marked as No. 1 on the upstream side of the tube furnace, that is, on the side of the argon inlet, and place the porcelain boat marked as No. 2 on the heat source center of the tube furnace. The two porcelain boats are adjacent to each other. Before heating the tube furnace, first introduce argon gas for 1 h to remove oxygen in the tube furnace. After removing the oxygen in the tube furnace, set the temperature of the tube furnace to 1000° C., and program the temperature at a rate of 5° C. min⁻¹. Heat the tube furnace under the protection of Ar gas, and continue calcining at high temperature for 1 h.

(7) Stop the reaction, wait for it to cool naturally to room temperature, and grind and collect the black product after the reaction to obtain a transition metal sulfide adsorbent.

### Example 4

A method for preparing a transition metal sulfide adsorbent comprises the following steps:

(1) Weigh 0.8 g of molybdenum trioxide and dissolve it in a single-necked flask containing 20 mL of deionized water and 100 mL of solvent, and perform ultrasonic stirring for 10 min to form a uniformly dispersed solution.

(2) Add 0.4 g of imidazole to the uniformly dispersed solution until fully mixed and then continuously ultrasonically stir for 10 min.

(3) Put a polytetrafluoroethylene magnetic stirring bar on the three-necked flask, transfer the single-necked flask containing the mixture to a constant temperature oil bath for heating reaction, the oil bath temperature is constant controlled at 100° C., condensed water is introduced for condensation reflux, the reaction time is 72 h, and the mechanical stirring speed is controlled at 300 rmp/min.

(4) After the reaction, cool the single-necked flask at room temperature, filter the white precipitate in the single-necked flask, wash the precipitate three times with deionized water and three times with ethanol, and finally dry the white solid in a vacuum drying oven at 80° C. for 24 h. The white powder obtained by grinding is Mo-MOF.

(5) Transfer thiourea to the porcelain boat marked No. 1 and weigh the Mo-MOF in the porcelain boats marked No. 1 and No. 2 at a mass ratio of 3:1. At the same time, the two raw materials need to be evenly spread in their respective magnetic boats.

(6) Place the porcelain boat marked as No. 1 on the upstream side of the tube furnace, that is, on the side of the argon inlet, and place the porcelain boat marked as No. 2 on the heat source center of the tube furnace. The two porcelain boats are adjacent to each other. Before heating the tube furnace, first introduce argon for 1 h to remove oxygen in the tube furnace. After removing the oxygen in the tube furnace, set the temperature of the tube furnace to 1000° C., and program the temperature at a rate of 5° C. mind. Heat the tube furnace under the protection of Ar gas, and continue calcining at high temperature for 1 h.

(7) Stop the reaction, wait for it to cool naturally to room temperature, and grind and collect the black product after the reaction to obtain a transition metal sulfide adsorbent.

### Example 5

A method for preparing a transition metal sulfide adsorbent comprises the following steps:

(1) Weigh 0.8 g of molybdenum trioxide and dissolve it in a single-necked flask containing 40 mL of deionized water and 100 mL of solvent, and perform ultrasonic stirring for 10 min to form a uniformly dispersed solution.

(2) Add 0.3 g of imidazole to the uniformly dispersed solution until fully mixed and then continuously ultrasonically stir for 10 min.

(3) Put a polytetrafluoroethylene magnetic stirring bar on the three-necked flask, transfer the single-necked flask containing the mixture to a constant temperature oil bath for heating reaction, the oil bath temperature is constant controlled at 200° C., condensed water is introduced for condensation reflux, the reaction time is 12 h, and the mechanical stirring speed is controlled at 300 rmp/min.

(4) After the reaction, cool the single-necked flask at room temperature, filter the white precipitate in the single-necked flask, wash the precipitate three times with deionized water and three times with ethanol, and finally dry the white solid in a vacuum drying oven at 80° C. for 24 h. The white powder obtained by grinding is Mo-MOF.

(5) Transfer thiourea to the porcelain boat marked No. 1 and weigh the Mo-MOF in the porcelain boats marked No. 1 and No. 2 respectively according to the mass ratio of 3:1. At the same time, the two raw materials need to be evenly spread in their respective magnetic boats.

(6) Place the porcelain boat marked as No. 1 on the upstream side of the tube furnace, that is, on the side of the argon inlet, and place the porcelain boat marked as No. 2 on the heat source center of the tube furnace. The two porcelain boats are adjacent to each other. Before heating the tube furnace, first introduce argon for 1 h to remove oxygen in the tube furnace. After removing the oxygen in the tube furnace, set the temperature of the tube furnace to 1000° C., and program the temperature at a rate of 5° C. min⁻¹. Heat the tube furnace under the protection of Ar gas, and continue calcining at high temperature for 1 h.

(7) Stop the reaction, wait for it to cool naturally to room temperature, and grind and collect the black product after the reaction to obtain a transition metal sulfide adsorbent.

### Comparative Example 1

A method for preparing a transition metal sulfide adsorbent comprises the following steps:

(1) Weigh 0.8 g of molybdenum trioxide and dissolve it in a single-necked flask containing 60 mL of deionized water and 100 mL of solvent, and perform ultrasonic stirring for 10 min to form a uniformly dispersed solution.

(2) Add 0.2 g of imidazole to the uniformly dispersed solution until fully mixed and then continuously ultrasonically stir for 10 min.

(3) Put a polytetrafluoroethylene magnetic stirring bar on the three-necked flask, transfer the single-necked flask containing the mixture to a constant temperature oil bath for heating reaction, the oil bath temperature is constant controlled at 120° C., and condensed water is introduced for condensation reflux. The reaction time is 24 h, and the mechanical stirring speed is controlled at 300 rmp/min.

(4) After the reaction, cool the single-necked flask at room temperature, filter the white precipitate in the single-necked flask, wash the precipitate three times with deionized water and three times with ethanol, and finally dry the white solid in a vacuum drying oven at 80° C. for 24 h. The white powder obtained by grinding is Mo-MOF.

(5) Transfer thiourea to the porcelain boat marked No. 1 and weigh the Mo-MOF in the porcelain boats marked No. 1 and No. 2 in a mass ratio of 3:1. At the same time, the two raw materials need to be evenly spread in their respective magnetic boats.

(6) Place the porcelain boat marked as No. 1 on the upstream side of the tube furnace, that is, on the side of the argon inlet, and place the porcelain boat marked as No. 2 on the heat source center of the tube furnace. The two porcelain boats are adjacent to each other. Before heating the tube furnace, first introduce argon gas for 1 h to remove oxygen in the tube furnace. After removing the oxygen in the tube furnace, set the temperature of the tube furnace to 400° C., and program the temperature at a rate of 5° C. min⁻¹. Heat the tube furnace under the protection of Ar gas, and continue calcining at high temperature for 1 h.

(7) Stop the reaction, wait for it to cool naturally to room temperature, and grind and collect the black product after the reaction to obtain a transition metal sulfide adsorbent, named MS-400.

### Comparative Example 2

A method for preparing a transition metal sulfide adsorbent comprises the following steps:

(1) Weigh 0.8 g of molybdenum trioxide and dissolve it in a single-necked flask containing 60 mL of deionized water and 100 mL of solvent, and perform ultrasonic stirring for 10 min to form a uniformly dispersed solution.

(2) Add 0.2 g of imidazole to the uniformly dispersed solution until it is fully mixed and then continuously ultrasonically stir for 10 min.

(3) Put a polytetrafluoroethylene magnetic stirring bar on the three-necked flask, transfer the single-necked flask containing the mixture to a constant temperature oil bath pot for heating reaction, the oil bath temperature is thermostatically controlled at 120° C., and condensed water is introduced for condensation reflux. The reaction time is 24 h, and the mechanical stirring speed is controlled at 300 rmp/min.

(4) After the reaction is completed, cool the single-necked flask at room temperature, filter the white precipitate in the single-necked flask, wash the precipitate three times with deionized water and three times with ethanol, and finally dry the white solid in a vacuum drying oven at 80° C. for 24 h. The white powder obtained by grinding is Mo-MOF.

(5) Transfer thiourea to the porcelain boat marked as No. 1 and weigh the Mo-MOF in the porcelain boats marked as No. 1 and No. 2 respectively according to the mass ratio of 3:1. At the same time, the two raw materials need to be evenly spread in their respective magnetic boats.

(6) Place the porcelain boat marked as No. 1 on the upstream side of the tubular furnace, that is, on the side of the argon inlet, and place the porcelain boat marked as No. 2 at the heat source center of the tubular furnace. The two porcelain boats are adjacent to each other. Before heating the tubular furnace, first introduce argon gas for 1 h to remove oxygen in the tubular furnace. After removing the oxygen in the tube furnace, the temperature of the tube furnace was set to 600° C., and the temperature was programmed to rise at a rate of 5° C. min⁻¹. The tube furnace was heated under Ar gas protection, and the high temperature was continued for 1 h.

(7) The reaction was stopped, and after naturally cooling to room temperature, the black product after the reaction was ground and collected to obtain a transition metal sulfide adsorbent, named MS-600.

### Comparative Example 3

A method for preparing a transition metal sulfide adsorbent comprises the following steps:

(1) Weigh 0.8 g of molybdenum trioxide and dissolve it in a single-necked flask containing 60 mL of deionized water and 100 mL of solvent, and ultrasonically stir for 10 min to form a uniformly dispersed solution.

(2) Add 0.2 g of imidazole to the uniformly dispersed solution until it is fully mixed and then continue ultrasonically stirring for 10 min.

(3) Put a polytetrafluoroethylene magnetic stirring bar on the three-necked flask, transfer the single-necked flask containing the mixture to a constant temperature oil bath for heating reaction, the oil bath temperature is constant controlled at 120° C., condensed water is introduced for condensation reflux, the reaction time is 24 h, and the mechanical stirring speed is controlled at 300 rmp/min.

(4) After the reaction, cool the single-necked flask at room temperature, filter the white precipitate in the single-necked flask, wash the precipitate with deionized water three times and ethanol three times, and finally dry the white solid in a vacuum drying oven at 80° C. for 24 h. The white powder obtained by grinding is Mo-MOF.

(5) Transfer thiourea to the porcelain boat marked No. 1 and weigh the Mo-MOF in the porcelain boats marked No. 1 and No. 2 in a mass ratio of 3:1. At the same time, the two raw materials need to be evenly spread in their respective magnetic boats.

(6) Place the porcelain boat marked as No. 1 on the upstream side of the tube furnace, that is, on the side of the argon inlet, and place the porcelain boat marked as No. 2 on the heat source center of the tube furnace. The two porcelain boats are adjacent to each other. Before heating the tube furnace, first introduce argon gas for 1 h to remove oxygen in the tube furnace. After removing the oxygen in the tube furnace, set the temperature of the tube furnace to 800° C., and program the temperature at a rate of 5° C. min⁻¹. Heat the tube furnace under the protection of Ar gas, and continue calcining at high temperature for 1 h.

(7) Stop the reaction, wait for it to cool naturally to room temperature, grind and collect the black product after the reaction to obtain a transition metal sulfide adsorbent, named MS-800.

### Comparative Example 4

A method for preparing a transition metal sulfide adsorbent comprises the following steps:

(1) Weigh 0.8 g of molybdenum trioxide and dissolve it in a single-necked flask containing 60 mL of deionized water and 100 mL of solvent, and perform ultrasonic stirring for 10 min to form a uniformly dispersed solution.

(2) Add 0.2 g of imidazole to the uniformly dispersed solution until fully mixed and then continuously ultrasonically stir for 10 min.

(3) Put a polytetrafluoroethylene magnetic stirring bar on the three-necked flask, transfer the single-necked flask containing the mixture to a constant temperature oil bath for heating reaction, the oil bath temperature is constant controlled at 120° C., condensed water is introduced for condensation reflux, the reaction time is 24 h, and the mechanical stirring speed is controlled at 300 rmp/min.

(4) After the reaction, cool the single-necked flask at room temperature, filter the white precipitate in the single-necked flask, wash the precipitate three times with deionized water and three times with ethanol, and finally dry the white solid in a vacuum drying oven at 80° C. for 24 h. The white powder obtained by grinding is Mo-MOF.

(5) Transfer thiourea to the porcelain boat marked No. 1 and weigh the Mo-MOF in the porcelain boats marked No. 1 and No. 2 in a mass ratio of 1:1. At the same time, the two raw materials need to be evenly spread in their respective magnetic boats.

(6) Place the porcelain boat marked as No. 1 on the upstream side of the tube furnace, that is, on the side of the argon inlet, and place the porcelain boat marked as No. 2 on the heat source center of the tube furnace. The two porcelain boats are adjacent to each other. Before heating the tube furnace, first introduce argon gas for 1 h to remove oxygen in the tube furnace. After removing the oxygen in the tube furnace, set the temperature of the tube furnace to 1000° C., and program the temperature at a rate of 5° C. min⁻¹. Heat the tube furnace under the protection of Ar gas, and continue calcining at high temperature for 1 h.

(7) Stop the reaction, wait for it to cool naturally to room temperature, and grind and collect the black product after the reaction to obtain a transition metal sulfide adsorbent.

### Comparative Example 5

A method for preparing a transition metal sulfide adsorbent comprises the following steps:

(1) Weigh 0.8 g of molybdenum trioxide and dissolve it in a single-necked flask containing 60 mL of deionized water and 100 mL of solvent, and perform ultrasonic stirring for 10 min to form a uniformly dispersed solution.

(2) Add 0.2 g of imidazole to the uniformly dispersed solution until fully mixed and then continuously ultrasonically stir for 10 min.

(3) Put a polytetrafluoroethylene magnetic stirring bar on the three-necked flask, transfer the single-necked flask containing the mixture to a constant temperature oil bath for heating reaction, the oil bath temperature is constant controlled at 120° C., and condensed water is introduced for condensation reflux. The reaction time is 24 h, and the mechanical stirring speed is controlled at 300 rmp/min.

(4) After the reaction, cool the single-necked flask at room temperature, filter the white precipitate in the single-necked flask, wash the precipitate three times with deionized water and three times with ethanol, and finally dry the white solid in a vacuum drying oven at 80° C. for 24 h. The white powder obtained by grinding is Mo-MOF.

(5) Transfer thiourea to the porcelain boat marked No. 1 and weigh the Mo-MOF in the porcelain boats marked No. 1 and No. 2 in a mass ratio of 2:1. At the same time, the two raw materials need to be evenly spread in their respective magnetic boats.

(6) Place the porcelain boat marked as No. 1 on the upstream side of the tube furnace, that is, on the side of the argon inlet, and place the porcelain boat marked as No. 2 on the heat source center of the tube furnace. The two porcelain boats are adjacent to each other. Before heating the tube furnace, first introduce argon gas for 1 h to remove oxygen in the tube furnace. After removing the oxygen in the tube furnace, set the temperature of the tube furnace to 1000° C., and program the temperature at a rate of 5° C. min⁻¹. Heat the tube furnace under the protection of Ar gas and continue calcining at high temperature for 1 h.

(7) Stop the reaction, wait for it to cool naturally to room temperature, and grind and collect the black product after the reaction to obtain a transition metal sulfide adsorbent.

### Result Analysis

### Preparation of Adsorption Solution

Ag⁺ solution was prepared by dissolving silver nitrate in ultrapure water. Preparation and determination of Ag⁺ solution: \textcircled{1} Prepare 2.0 g L⁻¹ Ag⁺ stock solution: Dissolve 3.1496 g AgNO₃ in 1 L ultrapure water and store in a refrigerator. \textcircled{2}Prepare Ag⁺ solutions of different concentrations: dilute 2.0 g L⁻¹ of Ag⁺ stock solution with deionized water to obtain Ag⁺ solutions with initial concentrations ranging from 50-2000 mg·L⁻¹. \textcircled{3}Prepare and measure the standard curve of Ag⁺ solution: dilute the Ag⁺ solution with 1% HNO₃ solution to obtain 6 different concentrations of Ag⁺ standard solutions, ranging from 0 to 6 mg L⁻¹. Use the continuous light source atomic absorption spectrometer ContrAA 700 for measurement, with absorbance as the ordinate and Ag⁺ solution concentration as the abscissa, and a straight line is obtained as the standard curve of Ag⁺ solution. \textcircled{4}Determination of Ag⁺ concentration in solution: Use a continuous light source atomic absorption spectrometer to measure the Ag⁺ concentration in the water sample to evaluate the removal effect of the adsorbent on Ag⁺. All experiments were carried out three times, and the final data is the average of the three experiments.

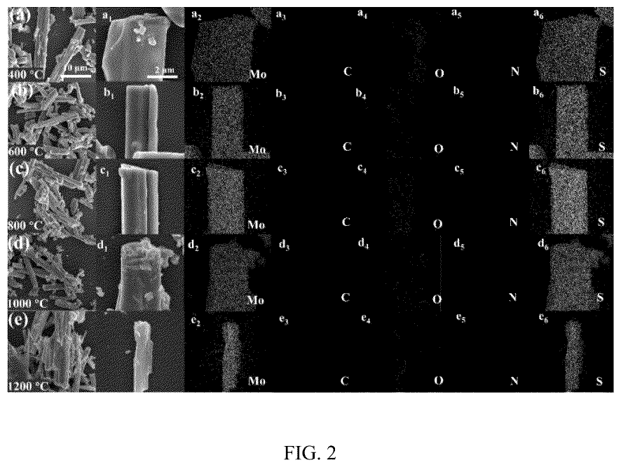

FIG. 2 is a SEM morphology of the transition metal sulfide adsorbent material prepared by Example 1-Example 2 of the present invention and Comparative Example 1-Comparative Example 3. It can be seen that the adsorbent material has a nanorod structure. As the reaction temperature increases, the generated nanorods become irregular, with a length of about 10 μm˜20 μm and a diameter of 1 μm˜2 μm. When the calcination temperature is increased from 400° C. to 800° C., sporadic fragments appear on the surface. When calcined at 1000° C., a dense structure formed by a large number of fragments is accumulated on the surface, and a multi-layer “cabbage” structure is formed inside from the cross section. This layered form is a typical MoS₂ structure, and there are a large number of fragments and particles embedded in the nanorods. When calcined at 1200° C., the nanorods become very thin, and the high temperature causes a large amount of cracking on the surface. In addition, the corresponding EDX-mapping can see the presence of the S element, which is the result of the reaction of H₂S produced by the decomposition of thiourea at high temperature with MOF. The adsorbent synthesized with Mo-MOF as a template maintains some of the morphology and structure of the original MOFs. The nanorod substrate can not only disperse the MoS₂ nanosheets well, but also expose more edge active sites, thereby greatly improving the material's removal performance for Ag⁺.

Weigh 20 mg of four different proportions of adsorbent materials and add them to 80 mL of a solution with a concentration of 2000 mg/L Ag⁺. Oscillate in a constant temperature oscillator at 298 K for 12 h, and set the speed to 180 rpm. After the oscillation ends and the balance is reached, the sample is filtered with a 0.22 m polyethersulfone membrane to obtain the supernatant, and the ContrAA 700 high-resolution continuous light source atomic absorption spectrometer is used to determine the Ag⁺ concentration before and after adsorption.

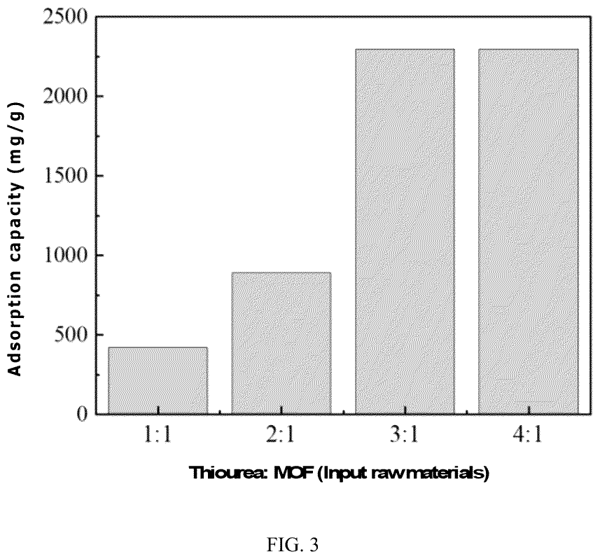

FIG. 3 is a graph showing the adsorption capacity of transition metal sulfide adsorbent materials thiourea and Mo-MOF at different ratios prepared in Examples 1 and 3 of the present invention and Comparative Examples 4 and 5. It can be seen from the figure that the adsorption performance of thiourea and Mo-MOF materials with a ratio of 3:1 and 4:1 is the best. This is mainly because the excess thiourea can decompose the thiourea at high temperature and fully contact the molybdenum atoms on the Mo-MOF to form molybdenum sulfide. Since the number of exposed molybdenum atoms is limited, even if more thiourea decomposes, the molybdenum sulfide formed is certain, so the adsorption amount no longer increases.

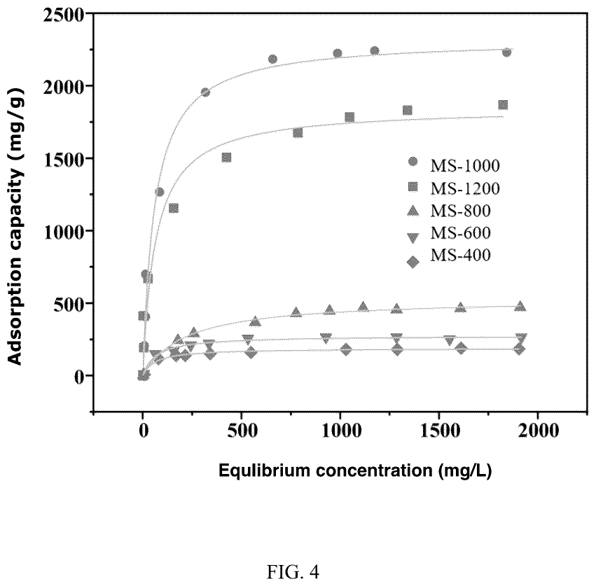

Isothermal adsorption: 20 mg of adsorbent nanorods calcined at different temperatures were added to 80 mL of Ag⁺ solutions of different concentrations. The isothermal adsorption experiments of Sb(V) were set at different temperatures of 283 K, 298 K and 318 K, and oscillated in a constant temperature oscillating box for 12 h, with a set speed of 180 rpm. The initial concentration of Ag⁺ in the adsorption solution ranged from 50 mg L⁻¹, 100 mg L⁻¹, 200 mg L⁻¹, 400 mg L⁻¹, 600 mg L⁻¹, 800 mg L⁻¹, 1000 mg L⁻¹, 1200 mg L⁻¹, 1400 mg L⁻¹, 1600 mg L⁻¹, 1800 mg L⁻¹, and 2000 mg L⁻¹. After adsorption equilibrium, the sample was filtered through a 0.22 m polyethersulfone membrane to obtain the supernatant, and the ContrAA 700 high-resolution continuous light source atomic absorption spectrometer was used to measure the Ag⁺ concentration before and after adsorption. FIG. 4 is a graph showing the adsorption capacity of transition metal sulfide adsorbent materials prepared at different calcination temperatures according to Examples 1 and 2 of the present invention and Comparative Examples 1 to 3. As can be seen from FIG. 4, the Ag⁺ removal capacities of MS-400, MS-600, MS-800, MS-1000 and MS-1200 nanorods are 172.1 mg g⁻¹, 250.2 mg g⁻¹, 484.8 mg g⁻¹, 2315.6 mg g⁻¹ and 1860 mg g⁻¹, respectively. MS-1000 has an ultra-high adsorption capacity superior to the other four materials, which is almost 13 times the adsorption capacity of MS-400, indicating that the nanorods generated at a calcination temperature of 1000° C. have the best Ag⁺ removal effect. This is mainly due to the formation of two different crystal phases of molybdenum sulfide 1T and 2H phases at 1000° C. The 1T phase molybdenum sulfide can reduce Ag⁺, and the 2H phase molybdenum sulfide provides a layered structure that is conducive to the transmission of Ag⁺ to the adsorption site and the formation of coordination.

20 mg of MS-1000 nanorod adsorbent was added to 20 mL of a mixed solution containing 10 ions of K+, Ca2+, Mg2+, Co2+, Ni2+, Cu2+, Cd2+, Zn2+, Pb2+ and Ag⁺ with a concentration of 1 mmol/L. Oscillate in a constant temperature oscillator at 298 K for 12 h. After adsorption equilibrium, the supernatant was collected by pinhole filter filtration, and the concentration of each component ion in the supernatant was determined using a ContrAA 700 high-resolution continuous light source atomic absorption spectrometer.

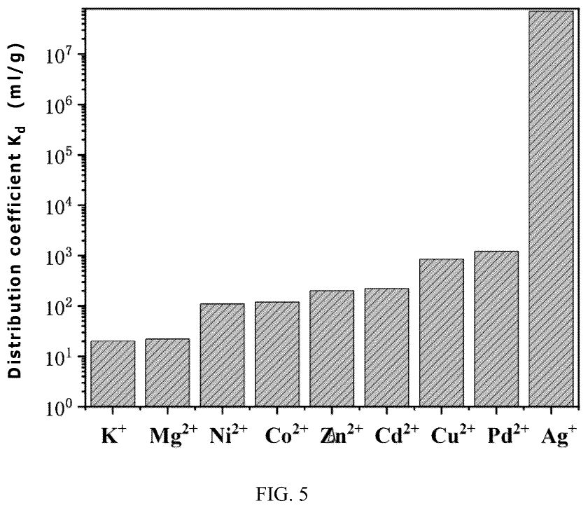

The selective removal of Ag⁺ was studied in a mixture of Ag⁺ and interfering ions K+, Mg2+, Ni2+, Co2+, Zn2+, Cd2+, Cu2+ and Pb2+. The affinity of MS-1000 nanorods to Ag⁺ can be evaluated by the distribution coefficient Kd, which is an important indicator for measuring the selectivity of the adsorbent. The Kd value of 1.0×105 mL g¹ can determine the selectivity of the adsorbent. FIG. 5 is an affinity diagram of the transition metal sulfide adsorbent prepared in Example 1 of the present invention for Ag⁺ in the presence of coexisting ions. It can be seen that the MS-1000 nanorod adsorbent can completely separate silver ions from other metal ions in a mixed solution, indicating that the MS-1000 nanorod adsorbent still has excellent selectivity for Ag⁺ in a complex silver-containing solution. This is mainly because as the calcination temperature increases, the more Mo atoms are exposed, the more molybdenum sulfide is formed. When it exceeds 1000° C., the structure of MOF is broken, and it is difficult to maintain the growth of more sites, resulting in a decrease in the adsorption amount.

In summary, the present invention uses the MOF template high temperature pyrolysis method to create active centers for both adsorption and reduction at the reaction interface of the adsorption material. The prepared MOF template-derived transition metal sulfur.

1. A method for preparing a transition metal sulfide adsorbent for targeted adsorption of silver from silver-containing wastewater, comprising:
synthesizing a Molybdenum-based metal-organic framework (Mo-MOF) template by a hydrothermal method;
calcining thiourea and the Mo-MOF template in a mass ratio of 3:1 to 4:1 under a protective atmosphere; and
obtaining a transition metal sulfide adsorbent by a high-temperature template cracking method,
wherein the calcination is performed at a temperature of 1000° C. to 1200° C., for 1 hour to 1.2 hours.

2. The method of claim 1, wherein synthesizing the Mo-MOF template comprises:
dissolving a molybdenum source in water to form a uniformly dispersed solution;
adding imidazole to the uniformly dispersed solution;
heating the solution to react; and
isolating the Mo-MOF template by post-treatment.

3. The method of claim 2, wherein the ratio of the molybdenum source mass to water volume is 4 g: 0.1 L to 0.3 L.

4. The method of claim 2, wherein the imidazole and molybdenum source are combined at a mass ratio of 4:1 to 4:2.

5. The method of claim 2, wherein the heating reaction is performed at a temperature of 100° C. to 200° C. for 12 h to 72 h.

6. A transition metal sulfide adsorbent obtained by the method according to claim 1.

7. An application of the transition metal sulfide adsorbent according to claim 6 in targeted adsorption of silver in silver-containing wastewater.

8. The use according to claim 7 characterized in that:
the concentration of silver in the silver-containing wastewater is 50 mg/L to 2000 mg/L, and the transition metal sulfide adsorbent is added to the silver-containing wastewater at a ratio of 1 mg of adsorbent in 2 mL to 4 mL of wastewater.
